(19) United States
(12) Patent Application Publication
(10) Pub. No.: US 2007/0112673 A1
(43) Pub. Date: May 17, 2007

(54) Method for autorising mandates of payment by credit cards and related apparatuses

(76) Inventor: Piero Protti, Roma (IT)

Correspondence Address: YOUNG & THOMPSON, 745 SOUTH 23RD STREET, 2ND FLOOR, ARLINGTON, VA, 22202, US

(21) Appl. No.: 10/561,918

(22) PCT Filed: Jun. 21, 2004
(86) PCT No.: PCT/IT04/00357

§ 371 Date: Sep. 11, 2006

(30) Foreign Application Priority Data
Jun. 23, 2003 (IT) RM2003A000311

(51) Int. Cl. G06Q 40/00; G06K 5/00

(52) U.S. Cl. 705/44; 235/380

(57) ABSTRACT

The invention concerns a method, and the related apparatuses, for authorizing mandates of payment through credit instruments, a user being the owner of at least one credit instrument, which is issued by an issuing institution (21) and of a telephone (20), which is provided with the functionality of sending and receiving radiotelephony messages, the method comprising the phases of A. the issuing institution checks the validity of the credit instrument, and B. the issuing institution sends to the commercial site a confirmation or refusal of authorization of the mandate of payment, C. sending from the use's telephone (20) to a radiotelephony message managing device (22) of a service center (21) of the issuing institution a radiotelephony message comprising a commercial site identification code, the amount of money and/or instrument identification data and/or user identification data and/or telephone identification data.

The present invention refers to a method for authorising mandates of payment, in particular by credit cards, employing telephone communications, preferably cellular radio telephony, the method enabling a very high safety, and being simple, reliable, and inexpensive to be realised.

The invention further refers to the apparatuse allowing the same method to be carried out.

The method of payment through the so-called credit cards is currently used and diffused. Such method, technically defined as mandate of payment, provides that the purchaser, called principal, of goods or services assigns to the vendor, called mandatee, an intermediary, called proxy, which binds itself in place of the purchaser to pay the price for the goods or services provided by the vendor. The intermediary is an institution issuing credit cards which takes responsibility for making payments due to the vendor and for drawing, in a moment that is delayed with respect to the moment of the purchase, the due money from the purchaser. The authorisation of mandate is given by the issuing institution after recognition of credit card data as valid, in particular the card identification number.

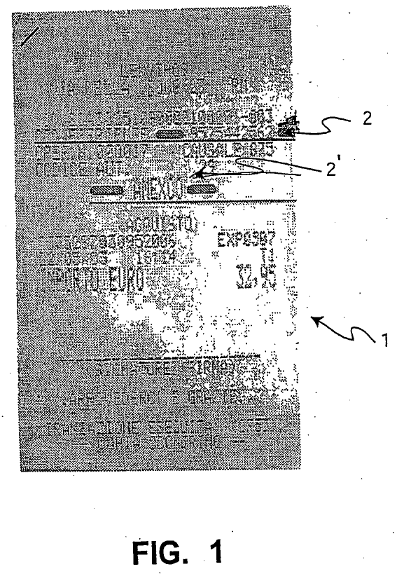

Usually, the purchaser, which is the owner of a credit card issued by the issuing institution and provided with the owner's personal data, the identification number and an expiry date, signs a sale document, wherein the details of the made business operation are reported, that he gives to the seller. In FIG. 1 by way of example a sample 1 of such sale document is shown, which reports the seller identification data, i.e. the Vendor Code Number 2, and an identifier 2′ of the credit card issuing institution. In particular, the sale document is printed by a device which automatically reads the card, usually through magnetic means.

In case of payment operations carried out on the Internet network, the purchaser restricts himself to communicating to the seller the issuing institution and the identification number of the credit card and, possibly, the expiry date and the owners personal data. More specifically, the purchaser, purchasing on an Internet site through a credit card, is connected, at the time of the purchase, to a page controlled by a bank server within which, after having inserted all the data of his credit card, the transaction is carried out.

However, the present transaction method via credit cards is still bound to traditional procedures and services which have never evolved along with the technology progress and, consequently, suffer from some drawbacks.

First of all, transactions have not yet been made safe, since the risk that someone misappropriate identification data of a credit card is always present.

Moreover, further problems appear when using credit cards for transactions on the Internet network. This is reflected in a psychological fear of the users in using credit cards on the Internet which slows down the diffusion of the concerned transactions on the network. In fact, an inquiry, conducted in 16 countries of the most industrialised world by the company Ipsos—Reid specialised in market searches, has revealed that 46% of interviewed people believe that credit card fraud is the main problem of commerce on the Internet.

Issuing companies have developed some solutions to these drawbacks, such as issuing prepaid cards, which however present the problem of having a purchase maximum limit and which may be used only on specific affiliated site and not at an international level, or even as issuing cards provided with chip-type microprocessors, which however do not assure a full 100% safety and do not at all change with respect to the use of credit cards through the Internet network, while they increase the production cost of the same credit cards and of the related POS readers.

It is therefore an object of the present invention to grant a very high secrecy and safety in authorising mandates of payment, in particular for payments by credit cards, still more preferably through the Internet, in a simple, reliable, and unexpensive way.

It is specific subject matter of this invention a method for authorising mandates of payment through credit instruments, wherein a user purchases at least one item of goods and/or at least one service in a commercial site in exchange for the payment of an amount of money, the user being the owner of at least one credit instrument, which is issued by an issuing institution and univocally determined by credit instrument identification data, and of a telephone, which is provided with the functionality of sending and receiving radiotelephony messages, the method comprising the phases of
A. the issuing institution checks the validity of the credit instrument, and
B. the issuing institution sends to the commercial site a confirmation or refusal of authorisation of the mandate of payment, depending on the outcome of the check,
   the method being characterised in that it comprises the following preliminary phase:
C. sending from the user's telephone to a radiotelephony message managing device of a service centre of the issuing institution a radiotelephony message comprising a commercial site identification code, the amount of money and/or instrument identification data and/or user identification data and/or telephone identification data,
   the commercial site identification code and the amount of money being inputted by the user during composition of the message.

Always according to the invention, the instrument identification data and/or the user identification data and/or the telephone identification data may be memorised in the telephone.

Still according to the invention, the instrument identification data and/or the user identification data and/or the telephone identification data may be inputted by the user during composition of the message.

Preferably according to the invention, the radiotelephony messages are SMS and/or MMS messages.

Furthermore according to the invention, the telephone may be a radiotelephone, preferably a cellular radiotelephone.

Always according to the invention, the commercial site may be a commercial site accessible via computer through a network, preferably accessible via the Internet.

Still according to the invention, the commercial site may be an automatic cash dispenser.

Furthermore according to the invention, the SMS message managing device may be incorporated in the service centre of the issuing institution.

Always according to the invention, the SMS message managing device may be a radiotelephony message managing server which communicates with the service centre.

Still according to the invention, the method may comprise the following phase after phase C:
D. sending from the radiotelephony message managing device of the service centre to the user's telephone a radiotelephony message comprising an information related to the confirmation or refusal of authorisation of the mandate of payment.

Furthermore according to the invention, the radiotelephony message sent during phase C may further comprise a request of authorisation of the mandate of payment.

Always according to the invention, the method may further comprise the following phases after phase C:
E. sending from the radiotelephony message managing device of the service centre to the user's telephone a radiotelephony message comprising at least an information indicative of the commercial site and/or the amount of money;
F. the user inputs in the telephone an indication related to the correctness of the information received by means of the message sent by the device during phase E;
   the phase C being performed only if the user inputs an indication of confirmation of the correctness of the information received by means of the message sent by the device during phase E.

Still according to the invention, the telephone may be provided with an operating mode for using credit instruments which is selectable by the user.

Furthermore according to the invention, said operating mode may comprise operations of checking the user's entitlement based on the input of passwords.

Always according to the invention, in the operating mode for using credit instruments the user may select a credit instrument.

Still according to the invention, the method may further comprise the following phase prior to phase C:
G. sending from the radiotelephony message managing device of the service centre to the user's telephone a predefined radiotelephony message, comprising blank fields related to the commercial site identification code and/or the amount of money which are filled by the user.

Furthermore according to the invention, the method may further comprise the following phase after phase D:
H. saving transaction data in the telephone, preferably under selection by the user.

Always according to the invention, said operating mode for using credit instruments may comprise a selectable sub-mode for setting data related to a credit instrument which are memorised in the telephone.

Still according to the invention, the radiotelephony message sent during phase C may comprise the IMEI (International Mobile Equipment Identity) code of the telephone and during phase A the issuing institution may check that the IMEI code corresponds to the user and/or to the radiotelephone and/or to the credit instrument.

Furthermore according to the invention, after phase C, the service centre of the issuing institution may transmit to a user's email address an email message reporting the confirmation or refusal of authorisation of the mandate of payment.

Preferably according to the invention, the credit instrument is a credit card.

Always according to the invention, the credit instrument may comprise a magnetic stripe and/or an electronic chip.

Still according to the invention, the telephone may be provided with at least one slot comprising an interface for reading the magnetic stripe and/or the electronic chip of credit instruments so as to read credit instrument data to be inserted in the radiotelephony message sent during phase C.

It is still specific subject matter of this invention a radiotelephony message managing device characterised in that it is apt to operate as radiotelephony message managing device of a service centre of an institution issuing credit instruments in the just described method for authorising mandates of payment through credit instruments.

It is also specific subject matter of this invention a telephone provided with the functionality of sending and receiving radiotelephony messages, characterised in that it is apt to operate as user's telephone in the previously described method for authorising mandates of payment through credit instruments.

Further details and embodiments of the present invention are described in the dependent claims.

The present invention will be now described, by way of illustration and not by way of limitation, according to its preferred embodiments, by particularly referring to the Figures of the enclosed drawings, in which:

FIG. 1 shows a sale document printed at the end of a transaction carried out through credit card;

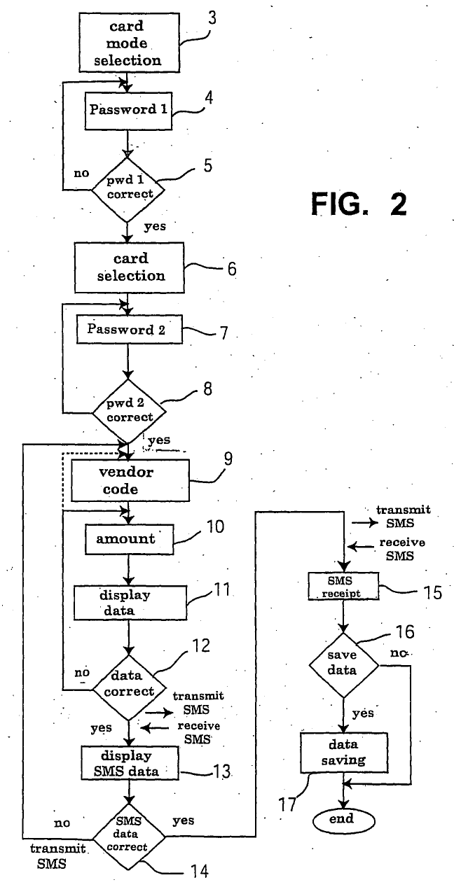

FIG. 2 shows a schematic diagram of a first portion of operations of authorisation of payment by credit card carried out through a first embodiment of the method according to the invention;

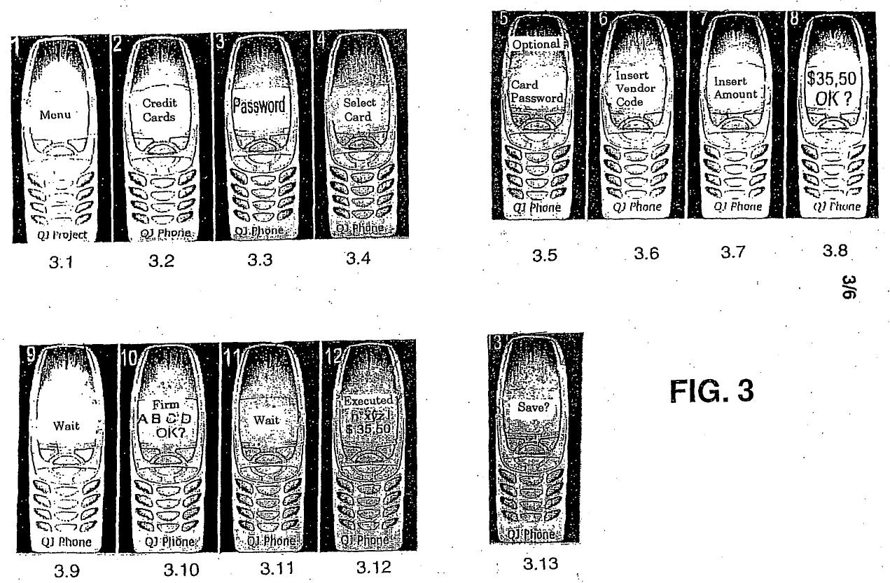

FIGS. 3.1-3.13 show the succession of information displayed on a cellular radiotelephone performing the method of FIG. 1;

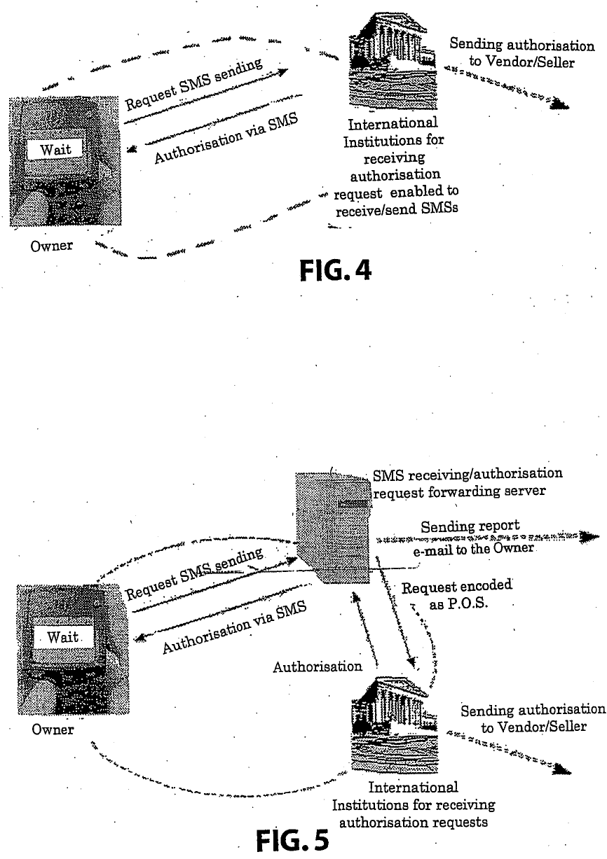

FIG. 4 shows a schematic diagram of a second portion of operations of authorisation of payment by credit card carried out through the method of FIG. 1;

FIG. 5 shows a schematic diagram of a second portion of operations of authorisation of payment by credit card carried out through a second embodiment of the method according to the invention;

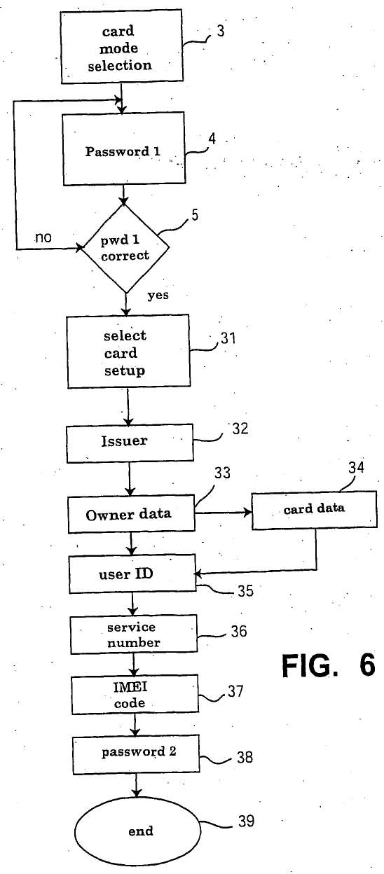

FIG. 6 shows a schematic diagram of operations of setting a cellular radiotelephone apt to perform the method of FIG. 1; and

FIGS. 7.1-7.12 show the succession of information displayed on the cellular radiotelephone during the setting operations of FIG. 7.

In the following of the description same references will be used to indicate alike elements in the Figures.

The method according to the invention is based on the use of telephones, preferably cellular radiotelephones, for requesting and authorising mandates of payment by credit cards, which are provided with a processing unit (of the type present in the SIM card of usual cellular radiotelephones), a memory unit, a display, and an alphanumeric keypad. In this regard, fixed telephones provided with the functionality of sending and receiving SMS messages may be used in the same way as cellular radiotelephones. More in particular, the method according to the invention allows owners of credit cards to carry out all the transactions by personally using the telephone for purchases in traditional or Internet accessible commercial sites, which have an agreement with the credit cards issuing institutions.

A user, wishing to make a purchase in a commercial site through a mandate of payment by credit card in conformity with a first embodiment of the method according to the invention, uses his/her own cellular radiotelephone.

With reference to FIG. 2, the operations which are carried out are the following ones:
the user select on the radiotelephone a credit card use mode (operation referred to with numeral 3 in FIG. 2), wherein the cellular radiotelephone display could display the selection information as shown in FIGS. 3.1 and 3.2;
the user inputs through the radiotelephone keypad a first password enabling the use of the credit card use mode (operation 4 of FIG. 2), wherein the radiotelephone display could display the request for password input as shown in FIG. 3.3;
the radiotelephone processing unit checks whether the first password enabling the use of the credit card use mode is correct (operation 5 of FIG. 2): if the check result is negative, it is necessary to repeat the operation 4 of password input, otherwise the flow passes to the following operation 6;
the user select on the radiotelephone a credit card (operation 6 of FIG. 2), wherein the cellular radiotelephone display could display the request for selection as shown in FIG. 3.4;
the user inputs through the radiotelephone keypad a second password enabling the use of the selected credit card (operation 7 of FIG. 2), wherein the radiotelephone display could display the request for password input as shown in FIG. 3.5;
the radiotelephone processing unit checks whether the second password enabling the use of the selected credit card is correct (operation 8 of FIG. 2): if the check result is negative, it is necessary to repeat the operation 7 of password input, otherwise the flow passes to the following operation 9;
the user inputs through the radiotelephone keypad an identification code of the commercial site in which he/she wishes to purchase (operation 9 of FIG. 2), wherein the radiotelephone display could display the request for commercial site code input as shown in FIG. 3.6;
the user inputs through the radiotelephone keypad the amount to be credited to the commercial site (operation 10 of FIG. 2), wherein the radiotelephone display could display the request for the amount input as shown in FIG. 3.7;
the radiotelephone processing unit displays on the display the inputted amount and, possibly, the inputted commercial site code (operation 11 of FIG. 2), and displays a request for confirmation to the user, as shown in FIG. 3.8;
the user inputs a reply to the confirmation request, reply which is checked by the radiotelephone processing unit (operation 12 of FIG. 2): if the confirmation by the user is negative, it is necessary to repeat the operation 10 of amount input and, possibly, also the operation 9 of commercial site code input (short dashes line from operation 12 to operation 9 of FIG. 2), otherwise if the confirmation by the user is positive, the radiotelephone processing unit transmits a first SMS message, comprising the transaction data inputted by the user and the selected credit card data (possibly along with the IMEI—International Mobile Equipment Identity—code of the radiotelephone) to a service centre of the institution issuing the credit card and puts itself in wait for receiving from the service centre a second SMS message of request for confirmation of data correctness, as shown in FIG. 3.9, before carrying out the following operation 13;
the radiotelephone processing unit displays on the display the data received from the service centre, preferably commercial site identification data (such as name and possibly address), (operation 13 of FIG. 2), and displays a confirmation request to the user, as shown in FIG. 3.10;
the user inputs a reply to the confirmation request, reply which is checked by the radiotelephone processing unit (operation 14 of FIG. 2): if the confirmation by the user is negative, it is necessary to repeat the previous operations starting from operation 9 of commercial site code input and the radiotelephone processing unit transmits a third SMS message of resetting of transaction data at previously sent to the service centre, otherwise if the confirmation by the user is positive, the radiotelephone processing unit transmits a fourth SMS message of request for authorisation to the service centre and puts itself in wait for receiving from the service centre a fifth SMS message of granted or denied authorisation of the transaction, as shown in FIG. 3.11, before carrying out the following operation 15.

In particular, with reference to FIG. 4, It may be observed that in the case of a transaction in a conventional commercial site (such as a shop), the user's radiotelephone 20 sends the fourth SMS message of authorisation request to the service centre 21 (into which a SMS message control device is integrated), which carries out the usual checks for ascertaining the regularity of the request and recognising the validity of the credit card data (possibly checking that the received IMEI code actually corresponds to the radiotelephone number and/or to the credit card). In fact, the credit card data (possibly along with the radiotelephone IMEI code) are automatically sent by the cellular radiotelephone with the first SMS message and/or with the fourth SMS message. In the case when the authorisation is granted, the service centre 21 transmits, in a conventional way, to the commercial site a POS message on the outcome of the payment authorisation request, which causes the printing of a sale document such as the one shown in FIG. 1, so that, in the case when the authorisation is granted, the commercial site gives the purchased goods or services to the user.

With reference to FIG. 5, an alternative embodiment of the method according to the invention could be such that the user's radiotelephone 20 sends a fourth SMS message of authorisation request to a SMS message control server 22 operating for the service centre 21, the latter carrying out the usual checks for ascertaining the regularity of the request and recognising the validity of the credit card data. The outcome of the authorisation is communicated by the service centre 21 to the server 22 and it is sent through SMS message by this to the user's radiotelephone 20, while the service centre 21 transmits, in a conventional way, to the commercial site a POS message on the outcome of the payment authorisation request. Possibly, the server 22 may also transmit to a user's email address an email message reporting the authorised transaction or the denied authorisation.

In case of purchases via the Internet, the commercial web site displays a message related to the outcome of the transaction authorisation request, in a way just identical to what presently already occurres.

Still with reference to FIG. 2, the subsequent operations of the method are the following:
the radiotelephone processing unit displays on the display the outcome of the payment authorisation request (operation 15 of FIG. 2), and displays a request for selection of transaction (or payment authorisation request, in the case when this has been denied) data saving, as shown in FIG. 3.13;
the user inputs a reply to the data saving request, reply which is checked by the radiotelephone processing unit (operation 16 of FIG. 2): if the request by the user is positive, the radiotelephone processing unit memorises the data;
finally, the operations of the method related to the current transaction end.

Other embodiments of the method according to the invention do not comprise operations 7 and 8 of input and check of correctness of the second password enabling the use of the selected credit card. The execution of the operations shown in FIG. 2 may be interrupted at any time by the user by pressing a suitable key or a specific combination of keys.
Still other embodiments of the method according to the invention may comprise a different message exchange between radiotelephone and service centre: the user could only input an its own user identification code and the second password enabling the use of the selected credit card (data known by the issuing institution) and the radiotelephone could send a SMS or MMS message only including such data, in response to which the service centre could send to the radiotelephone a predefined SMS or MMS message that the user shall have to send back to the service centre after having filled suitable fields thereof in (such as the commercial site identification code and the amount), and then the user waits for the outcome of the check.
In case of purchases via the Internet, the user who selects a product/service to purchase on the commercial web site could click on an area corresponding to the issuing institution of the card that he/she wishes to use (and comprising information on the commercial site identification code) and he/she could automatically linked to the issuing institution web site, in which he/she should only input his/her own user identification code (and possibly the amount to be authorised), since the other data may be automatically communicated by the commercial web site to the issuing institution.

In further embodiments of the method according to the invention, the users' radiotelephones may be provided with a slot comprising an interface for reading the magnetic stripe and/or the chip of credit cards. In such a case, once the credit card has been read, the user must only input the commercial site identification code, the amount to be authorised and possibly the enabling second password, and then he/she sends to the service centre the SMS or MMS message of authorisation request.

With reference to FIG. 6, the operations which are carried out by the first embodiment of the method according to the invention for setting data of a credit card into the user's cellular radiotelephone comprises the already illustrated operations 3, 4, and 5 and the further following operations:
the user selects on the radiotelephone a credit card setting mode (operation 31 of FIG. 6), wherein the cellular radiotelephone display could display the request for selection as shown in FIG. 7.4;
the user inputs through the radiotelephone keypad an identification code of the credit card issuing institution (operation 32 of FIG. 6), wherein the radiotelephone display could display the request for institution code input as shown in FIG. 7.5;
the user inputs through the radiotelephone keypad the data of the credit card owner, such as his/her name, (operation 33 of FIG. 6), wherein the radiotelephone display could display the request for owner data input as shown in FIG. 7.6;
the user inputs through the radiotelephone keypad the credit card data, such as its number and expiry date, (operation 34 of FIG. 6), wherein the radiotelephone display could display the request for credit card data input as shown in FIG. 7.7;
the user inputs through the radiotelephone keypad a user identification code, such as an alphanumeric code (operation 35 of FIG. 6), wherein the radiotelephone display could display the request for user code input as shown in FIG. 7.8;
the user inputs through the radiotelephone keypad the cellular radiotelephony number corresponding to the service centre (or to its server) of the issuing institution (operation 36 of FIG. 6), wherein the radiotelephone display could display the request for inputting the number to be contacted as shown in FIG. 7.9;
the user inputs through the radiotelephone keypad the radiotelephone IMEI number (operation 37 of FIG. 6), wherein the radiotelephone display could display the request for IMEI code input as shown in FIG. 7.10;
the user inputs through the radiotelephone keypad the password enabling the use of the credit card (operation 38 of FIG. 6), wherein the radiotelephone display could display the request for password input as shown in FIG. 7.11;
the radiotelephone processing unit memorises all the inputted data (operation 39 of FIG. 6), displaying an information of setting end as shown in FIG. 7.12.
   Other embodiments of the method according to the invention do not comprise the operation 38 of input of the password enabling the use of the credit card that is being set up. Further embodiments of the method according to the invention do not non comprise the operation 37 of input of the IMEI code, which may be automatically associated to the credit card by the radiotelephone processing unit). The execution of the operations shown in FIG. 6 may be also interrupted at any time by the user by pressing a suitable key or a specific combination of keys.
   The method according to the invention provides that each commercial site, possibly accessible via the Internet, exhibits its own “Vendor Code” related to a specific credit card issuing institution, number which may be the current one (shown in FIG. 1 with the numeral 2) or an “alias” specifically assigned by the issuing institutions to the commercial sites affiliated with the method according to the invention. Preferably, hence the commercial sites exhibit an issuing institution symbol showing the “vendor Code” up, close to the cash desks of the shop or on a suitable indicator on at least one page of the related Internet site.
   Obviously, telephone SIM Cards may be easily provided with the new credit card use functionality.
   The method according to the invention may be easily implemented by exploiting many of the already existing technologies. In fact, the issuing institutions presently receive messages sent by the POS equipments of the commercial sites (also the ones accessible via the Internet) which are routed by authorisation request centres. By adapting the present systems to receiving and sending SMS and/or MMS telephone messages, it is possible to implement the method according to the invention.
   It is sufficient that credit card owners receive the list of cellular radiotelephony numbers (related to each country in the world) to dial, which will be memorised by the owner in the radiotelephone during setting a credit card.
   Through specific agreements, the issuing institutions will be able to give the traffic of cellular radiotelephony messages, such as SMS or MMS, generated by the method according to the invention, in charge to third parties, advantageously to the mobile telephony companies present in the various countries of the world.
   As said before, the service centre communicating through SMS or MMS messages with the users' radiotelephones could advantageously also check whether the IMEI code of the calling handset conforms with users' data. This makes any intrusion into databases and/or any attempt of fraudulent use unuseful when performed by people who have accidentally known data of others. In fact, as known, the IMEI code is a 15 digit number identifying each single radiotelephone, comprising six digits (Tac—Type Approval Code) indicating the code of the country and of the manufacturer, two digits (Fac—Final Assembly Code) indicating the code of the manufacturer itself, further six digits (Snr—Serial Number) indicating the serial number of the handset, and a last digit (Sp—Spare) available at the moment for possible future uses.
   The method further offers the advantage of allowing the operations necessary for the transaction to be fastly and safely executed. In fact, the cellular radiotelephony messaging services are not interceptable and each sending of a message takes very few seconds. Therefore, the method according to the invention, along with the present communication systems, allows a transaction to be carried out in a period of about 10-20 seconds.
   Moreover, cellular radiotelephony message control devices (such as the server 22), especially when controlled by mobile telephony companies, may advantageously route to the issuing institutions the received data in an encoded manner. Preferably, the SIM Cards provided with the “credit card” functionality, may already include cellular radiotelephony numbers corresponding to the service centres (or to the related servers) of the issuing institutions. Mobile telephony companies and/or issuing institutions may advantageously provide for sending SMS or MMS messages including the update of such cellular radiotelephony numbers (possibly corresponding to the geographical areas wherein the radiotelephone moves) which may be memorised in the radiotelephone.
   Manufacturers of radiotelephones may advantageously manufacture handsets provided with a special “Credit card” key.
   The use of the method according to the invention may be easily diffused by the issuing institutions to their own affiliated commercial sites. In fact, for instance it is sufficient to send a poster to be exhibited in the commercial site comprising the issuing institution symbol and the commercial site identification code. Similarly, commercial web sites are easily adaptable to the use of the method.
   The method according to the invention enables the complete removal of the fears of who does not use much the present systems not to give its own credit cards in charge to others, due to the fear that credit cards could be manipulated.
   By operating through the procedures of the method according to the invention, each owner of credit cards is capable to carry out ordinary transactions, and via the Internet, directly through a telephone, by personally dialing the data of the transaction of which he/she ask for authorisation without the seller or third parties have at hand his/her credit cards or his/her data. Nobody, least of all hackers or ill-disposed people, has at his disposal the credit card numbers.
   The method according to the invention grants the safety and, consequently, it may be foreseen that it will increase the number of transactions carried out in conventional or accessible via the Internet network commercial sites. The method according to the invention, though leaving substantially unchanged the current procedures of check and authorisation of transactions, does not impose that credit cards are given to the seller and neither provides that data of the same cards are communicated via the Internet.
   The method according to the invention gives a great impulse to the vast market represented by the Internet which nowadays produces a number of commercial transactions inferior to its potentiality, because of the users' fear of sending through the network data related to credit cards.
   Thanks to the method according to the invention, the users must not have any more at hand the credit cards in order to carry out a transaction, so minimising the risk of robbery or loss. In order to carry out transactions it is sufficient to use card data safely memorised in the radiotelephone.
   The method according to the invention is immediately implementable on world scale, since it operates through transmission and reception of cellular radiotelephony messages, hence by using GSM and/or GPRS and/or UMTS signals, which grant a network coverage over almost the whole terrestrial surface, allowing the users to carry out transactions substantially all over the world.
   The issuing institutions may possibly implement the method according to the invention without using specific SIM Cards, or without equipments preset to the method itself, by suitably organising the system of message receiving from and sending to the users.
   The accessible via the Internet commercial sites do not receive the credit card data, but only the outcome of the authorisation request in the same manner according to which they currently receive it. In fact, the users must not input the credit card data in a computer and communicate them via the Internet, risking that they are intercepted by unauthorised third persons.
   Even if it is very simple, the use of the radiotelephone makes the method according to the invention fast and inaccessible to ill-disposed people even in case of robbery or loss of the radiotelephone itself. In fact, each time the radiotelephone requires the input of at least one password enabling the use of the credit card use mode. Also, in case of robbery or loss of the radiotelephone the credit card owner may disable the only card use mode through the method according to the invention, continuing to be capable of using traditional methods.
   Advantageously, the method according to the invention may allow the users to use their own radiotelephones or corporate radiotelephones suitably provided with a corporate or “Business” credit card use mode. In fact, each radiotelephone may be set for using a plurality of credit cards.
   Through the method according to the invention, it is possible to preset additional services to users, such as sending advertising messages, statements of account, e-mails. All the above by assuring the privacy, since the method according to the invention may also require a password, effectively allowing only the card owner to read and delete messages.
   The method according to the invention may advantageously be also adopted by the banking and/or insurance system, for instance allowing the banking system to directly or indirectly manage SMS or MMS messages traffic by assigning to each automatic cash dispenser a related dispenser identification code similar to the commercial site identification code. In this way, it is possible for the Bancomat-ATM-lnteract users to carry out cash drawings practically in all areas of the world covered by a telephone network signal. Similarly, the insurance system may offer to its customers the chance of making payments.
   Even the oil companies may advantageously adopt the method according to the invention, by exhibiting in each filling station the corresponding identification code similar to the commercial site identification code.
   In conclusion, the advantages offered by the method according to the invention are many, in particular: reduced implementation costs, simplicity of use, versatility of application, safety of transactions even for transactions via the Internet, intrinsic adaptability to future technological advancements, coexistence with the present credit card use system.

The preferred embodiments have been above described and some modifications of this invention have been suggested, but it should be understood that those skilled in the art can make other variations and changes, without so departing from the related scope of protection, as defined by the following claims.

1. Method for authorising mandates of payment through credit instruments, wherein a user purchases at least one item of goods and/or at least one service in a commercial site in exchange for the payment of an amount of money, the user being the owner of at least one credit instrument, which is issued by an issuing institution (21) and univocally determined by credit instrument identification data, and of a telephone (20), which is provided with the functionality of sending and receiving radiotelephony messages, the method comprising the phases of
A. the issuing institution checks the validity of the credit instrument, and
B. the issuing institution sends to the commercial site a confirmation or refusal of authorisation of the mandate of payment, depending on the outcome of the check,
the method being characterised in that it comprises the following preliminary phase:
C. sending from the user's telephone (20) to a radiotelephony message managing device (22) of a service centre (21) of the issuing institution a radiotelephony message comprising a commercial site identification code, the amount of money and/or instrument identification data and/or user identification data and/or telephone identification data,
the commercial site identification code and the amount of money being inputted by the user during composition of the message.

2. Method according to claim 1, characterised in that the instrument identification data and/or the user identification data and/or the telephone identification data are memorised in the telephone (20).

3. Method according to claim 1, characterised in that the instrument identification data and/or the user identification data and/or the telephone identification data are inputted by the user during composition of the message.

4. Method according to claim 1, characterised in that the radiotelephony messages are SMS and/or MMS messages.

5. Method according to claim 1, characterised in that the telephone (20) is a radiotelephone.

6. Method according to claim 4, characterised in that the telephone (20) is a cellular radiotelephone.

7. Method according to claim 1, characterised in that the commercial site is a commercial site accessible via computer through a network.

8. Method according to claim 7, characterised in that the commercial site is a commercial site accessible via the Internet.

9. Method according to claim 1, characterised in that the commercial site is an automatic cash dispenser.

10. Method according to claim 1, characterised in that the SMS message managing device is incorporated in the service centre (21) of the issuing institution.

11. Method according to claim 1, characterised in that the SMS message managing device is a radiotelephony message managing server (22) which communicates with the service centre (21).

12. Method according to claim 1, characterised in that it comprises the following phase after phase C:
D. sending from the radiotelephony message managing device (22) of the service centre (21) to the user's telephone (20) a radiotelephony message comprising an information related to the confirmation or refusal of authorisation of the mandate of payment.

13. Method according to claim 1, characterised in that the radiotelephony message sent during phase C further comprises a request of authorisation of the mandate of payment.

14. Method according to claim 1, characterised in that it further comprises the following phases after phase C:
E. sending from the radiotelephony message managing device (22) of the service centre (21) to the user's telephone (20) a radiotelephony message comprising at least an information indicative of the commercial site and/or the amount of money;
F. the user inputs in the telephone (20) an indication related to the correctness of the information received by means of the message sent by the device (22) during phase E;
the phase C being performed only if the user inputs an indication of confirmation of the correctness of the information received by means of the message sent by the device (22) during phase E.

15. Method according to claim 11, characterised in that the telephone (20) is provided with an operating mode for using credit instruments which is selectable by the user.

16. Method according to claim 15, characterised in that the operating mode comprises operations of checking the user's entitlement based on the input of passwords.

17. Method according to claim 15, characterised in that in the operating mode for using credit instruments the user selects a credit instrument.

18. Method according to claim 15, characterised in that it further comprises the following phase prior to phase C:
G. sending from the radiotelephony message managing device (22) of the service centre (21) to the user's telephone (20) a predefined radiotelephony message, comprising blank fields related to the commercial site identification code and/or the amount of money which are filled by the user.

19. Method according to claim 15, when depending, characterised in that it further comprises the following phase after phase D:
H. saving transaction data in the telephone (20) preferably under selection by the user.

20. Method according to claim 15, characterised in that the operating mode for using credit instruments comprises a selectable sub-mode for setting data related to a credit instrument which are memorised in the telephone (20).

21. Method according to claim 1, characterised in that the radiotelephony message sent during phase C comprises the IMEI (International Mobile Equipment Identity) code of the telephone (20) and in that during phase A the issuing institution checks that the IMEI code corresponds to the user and/or to the radiotelephone and/or to the credit instrument.

22. Method according to claim 1, characterised in that, after phase C, the service centre (21) of the issuing institution transmits to a user's email address an email message reporting the confirmation or refusal of authorisation of the mandate of payment.

23. Method according to claim 1, characterised in that the credit instrument is a credit card.

24. Method according to claim 1, characterised in that the credit instrument comprises a magnetic stripe and/or an electronic chip.

25. Method according to claim 24, characterised in that the telephone (20) is provided with at least one slot comprising an interface for reading the magnetic stripe and/or the electronic chip of credit instruments so as to read credit instrument data to be inserted in the radiotelephony message sent during phase C.

26. Radiotelephony message managing device (22) characterised in that it is apt to operate as radiotelephony message managing device of a service centre (21) of an institution issuing credit instruments in the method for authorising mandates of payment through credit instruments according to claim 1.

27. Telephone (20) provided with the functionality of sending and receiving radiotelephony messages, characterised in that it is apt to operate as user's telephone in the method for authorising mandates of payment through credit instruments according to claim 1.

28. Method according to claim 1, characterised in that the telephone (20) is provided with an operating mode for using credit instruments which is selectable by the user.
